(19) United States
(12) Patent Application Publication
(10) Pub. No.: US 2019/0188916 A1
(43) Pub. Date: Jun. 20, 2019

(54) METHOD AND APPARATUS FOR AUGMENTING REALITY

(71) Applicants: Xiaoyin Zhang, Beijing (CN); Zhongqin Wu, Beijing (CN); Yingchao Li, Beijing (CN); Li Xu, Beijing (CN); Miao Yao, Beijing (CN); Yongjie Zhang, Beijing (CN); Qian Ying, Beijing (CN); Yuan Gao, Beijing (CN)

(72) Inventors: Xiaoyin Zhang, Beijing (CN); Zhongqin Wu, Beijing (CN); Yingchao Li, Beijing (CN); Li Xu, Beijing (CN); Miao Yao, Beijing (CN); Yongjie Zhang, Beijing (CN); Qian Ying, Beijing (CN); Yuan Gao, Beijing (CN)

(21) Appl. No.: 16/134,259

(22) Filed: Sep. 18, 2018

(30) Foreign Application Priority Data
Nov. 15, 2017 (CN) 201711132516.1

(51) Int. Cl. G06T 19/00; G06K 9/00; G06T 7/33

(52) U.S. Cl. CPC G06T 19/006; G06T 7/33; G06K 9/00671

(57) ABSTRACT

A method and apparatus for augmenting reality are disclosed. A specific embodiment of the method includes: recognizing an object in an image collected by a camera of a user terminal, and determining a space occupied by the recognized object in a world coordinate system; determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and superimposing, in an augmented reality, the augmented reality tag at the superimposition position. The direct association relationship between the superimposed information and the object in the real world is established.

### CROSS-REFERENCE TO RELATED APPLICATIONS

This application claims priority to Chinese Patent Application No. 201711132516.1, filed with the China National Intellectual Property Administration (CNIPA) on Nov. 15, 2017, the content of which is incorporated herein by reference in its entirety.

### TECHNICAL FIELD

The present disclosure relates to the field of computer technology, specifically to the field of augmented reality, and more specifically to a method and apparatus for augmenting reality.

### BACKGROUND

At present, augmented reality functions provided by the augmented reality (AR for short) application are generally through capturing an environment in the real world by the camera of a user terminal, and superimposing information on the captured image, to present the captured image superimposed with information to the user in a page. However, the direct association relationship between the superimposed information presented to the user and an object in the real world cannot be represented.

### SUMMARY

The present disclosure provides a method and apparatus for augmenting reality.

In a first aspect, the present disclosure provides a method for augmenting reality. The method includes: recognizing an object in an image collected by a camera of a user terminal, and determining a space occupied by the recognized object in a world coordinate system; determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and superimposing the augmented reality tag at the superimposition position in an augmented reality.

In a second aspect, the present disclosure provides an apparatus for augmented reality. The apparatus includes: a processing unit, configured to recognize an object in an image collected by a camera of a user terminal, and determine a space occupied by the recognized object in a world coordinate system; a determining unit, configured to determine a position in the world coordinate system corresponding to an augmented reality tag of the recognized object, and determine a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and a superimposing unit, configured to superimpose the augmented reality tag at the superimposition position in an augmented reality.

According to the method and apparatus for augmenting reality, through: recognizing an object in an image collected by a camera of a user terminal, and determining a space occupied by the recognized object in a world coordinate system; determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and superimposing the augmented reality tag at the superimposition position, in an augmented reality. The recognition of that the object in the real world superimposed with information such as augmented reality tag at the determined superimposition position is viewed by the user through the image collected by the camera is realized, the effect presented to the user is the same as if the information such as the augmented reality tag were near the object in the real world. The direct association relationship between the superimposed information and the object in the real world is established. Therefore, the user may get what he views from the object of the real world in the image collected by the camera.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a flowchart of an embodiment of a method for augmenting reality according to the present disclosure;

FIG. 2 is a schematic structural diagram of an embodiment of an apparatus for augmenting reality according to the present disclosure; and

FIG. 3 is a schematic structural diagram of a computer system adapted to implement a terminal according to embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure.

It should also be noted that the embodiments in the present disclosure and the features in the embodiments may be combined with each other on a non-conflict basis. The present disclosure will be described below in detail with reference to the accompanying drawings and in combination with the embodiments.

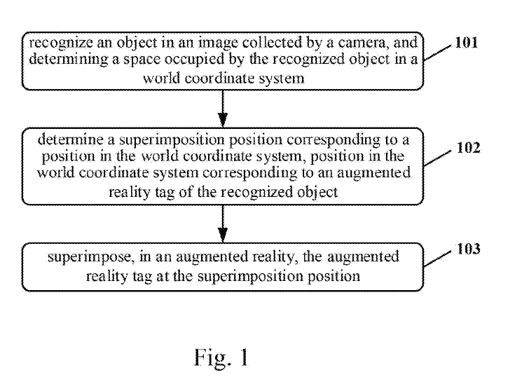

Referring to FIG. 1, which illustrates a flow of a method for augmenting reality according to an embodiment of the present disclosure. The method includes the following steps.

Step 101, recognizing an object in an image collected by a camera, and determining a space occupied by the recognized object in a world coordinate system.

When the camera of a user terminal is turned on, and when an object is within the range of the viewing angle of the camera, the image collected by the camera contains the object.

In this embodiment, image recognition may be performed on the image collected by the camera to recognize the object in the collected image. the number of recognized objects may be more than one.

For example, the user clicks a button for turning on the camera of the terminal on the screen of the terminal. When the terminal of the user is toward an office table, the table and objects on the office table, etc. are within the range of the viewing angle of the camera. The image recognition is performed on the collected image, objects such as the office table and the objects on the office table may be recognized.

The camera may collect one image every other collection cycle. Once the one image is collected by the camera, the image recognition may be performed on the image collected by the camera to recognize the objects in the collected image.

In this embodiment, the space occupied by the recognized object in the world coordinate system (i.e., in the real world) may be determined.

In some alternative implementations of this embodiment, when determining the space occupied by one recognized object in the world coordinate system, the space occupied by the recognized object in the world coordinate system may be determined based on a plurality of collected images containing the recognized object through SLAM (simultaneous localization and mapping). The plurality of collected images containing the recognized object may be images containing the recognized object which are collected by the camera during the moving of the user terminal in a certain duration.

For example, one recognized object is always within the range of the viewing angle of the camera during the moving of the user terminal in the certain duration, a plurality of images containing the recognized object may be collected in the certain duration. Three-dimensional point of the recognized object in the world coordinate system may be determined, through the SLAM, based on the matched feature point of the recognized object in the plurality of images collected by the camera. A plurality of three-dimensional points may respectively be determined. Then, based on the positions of the plurality of three-dimensional points of the recognized object in the world coordinate system, the space occupied by the recognized object in the world coordinate system is determined.

For example, the recognized object is a potted flower. It may be determined through the SLAM that each of the plurality of matched feature points of the potted flower in the plurality of images containing the potted flower and collected by the camera corresponds to an identical three-dimensional point of the potted flower in the real world. The plurality of three-dimensional points of the potted flower in the real world may represent the potted flower in the world coordinate system (i.e., the potted flower in the real world). Then, the space occupied by the potted flower in the world coordinate system may be determined.

Step 102, determining a superimposition position in the world coordinate system corresponding to a position corresponding to an augmented reality tag of the recognized object.

In this embodiment, the determined position in the world coordinate system corresponding to the augmented reality tag of the recognized object is associated with the space occupied by the recognized object in the world coordinate system. The determined position in the world coordinate system corresponding to the augmented reality tag may be in the space occupied by the recognized object in the world coordinate system, or the determined position in the world coordinate system corresponding to the augmented reality tag may be near the space occupied by the recognized object in the world coordinate system.

After the position in the world coordinate system corresponding to the augmented reality tag of the recognized object is determined, it may be determined that the position corresponding to the augmented reality tag of the recognized object in the world coordinate system is at the corresponding superimposition position in the collected image.

For example, the terminal of the user is toward the office table, the image collected by the camera of the user terminal may contain the objects on the office table. Thus, the objects on the office table may be recognized. For the recognized potted flower on the office table, the position corresponding to the augmented reality tag of the potted flower in the world coordinate system may be in the space occupied by the potted flower in the world coordinate system. The position corresponding to the augmented reality tag of the potted flower in the world coordinate system may be near the space occupied by the potted flower in the world coordinate system, for example, a little above the space occupied by the potted flower in the world coordinate system.

The camera may collect one image every other collection cycle. Once the one image is collected by the camera, the position in the world coordinate system corresponding to the augmented reality tag of the recognized object may be determined. Accordingly, the superimposition position in the collected image corresponding to the position in the world coordinate system corresponding to the augmented reality tag of the recognized object is determined.

Step 103, superimposing the augmented reality tag at the superimposition position in an augmented reality.

In this embodiment, the augmented reality tag of the recognized object may be in any shape, and the augmented reality tag may contain characters of the name of the recognized object.

After the superimposition position in the collected image corresponding to the position in the world coordinate system corresponding to the augmented reality tag of the recognized object is determined, the augmented reality tag of the recognized object may be superimposed at the superimposition position in the augmented reality. Accordingly, the effect presented to the user is as if the augmented reality tag were existed near each object (e.g., above the object) in the real world.

The camera may collect one image every other collection cycle. Once the one image is collected by the camera, the augmented reality tag may be superimposed at the determined superimposition position in the augmented reality.

For example, when the terminal of the user is toward an office table, the image collected by the camera of the terminal of the user contains the objects on the office table and the like. The objects on the office table may be recognized through image recognition. For the recognized potted flower on the office table, the position in the world coordinate system corresponding to the augmented reality tag of the potted flower may be in the space occupied by the potted flower in the world coordinate system. The position in the world coordinate system corresponding to the augmented reality tag of the potted flower may be near the space occupied by the potted flower in the world coordinate system, for example, a little above the space occupied by the potted flower in the world coordinate system. The augmented reality tag containing the word “flower” is superimposed at the position in the world coordinate system corresponding to the augmented reality tag of the potted flower. Therefore, the effect presented to the user is the same as that the augmented reality tag containing the word “flower” is superimposed on the plotted flower in the real world.

In some alternative implementations of this embodiment, a static state duration of the user terminal starting from the start moment of the user terminal being in the static state may be detected. That is, a duration during which the angle of the camera of the user terminal being unchanged is detected. When the static state duration of the user terminal is greater than a duration threshold, augmented reality information may be superimposed at the corresponding superimposition position in the collected image in the augmented reality. The position in the world coordinate system corresponding to the augmented reality tag of the recognized object is at the corresponding superimposition position in the collected image. Types of the augmented reality information of the recognized object may include, but not limited to, model, text, image, or video.

For example, the camera of the user terminal is kept toward the office table during the duration greater than the duration threshold, the user terminal is kept in the static state, and the angle of the camera of the user terminal is unchanged during the duration. The image collected by the camera of the user terminal may contain the objects on the office table, and the objects on the office table may be recognized through image recognition. At the end of the time period corresponding to the duration, for the recognized plotted flower on the office table, the augmented reality information of the plotted flower may be superimposed at the corresponding superimposition position in the collected image, where the superimposition position corresponds to the position in the world coordinate system corresponding to the augmented reality tag of the plotted flower. The augmented reality information of the plotted flower may be information introducing the plotted flower. The effect presented to the user is the same as that the information introducing the plotted flower is superimposed on the plotted flower in the real world.

In the process of detecting the static state duration of the user terminal, when the static state duration of the user terminal is less than the duration threshold and the user terminal moves, the start moment of the next process of detecting the static state duration of the user terminal is the start moment of the user terminal being in the static state after moving.

In some alternative implementations of this embodiment, a progress bar indicator may be superimposed onto the image collected by the camera of the user terminal, and present the progress bar indicator to the user. The progress bar indicator indicates the static state duration of the user terminal starting from the start moment of the user terminal being in the static state. Therefore, the user may know the static state duration of the user terminal through the progress bar indicator.

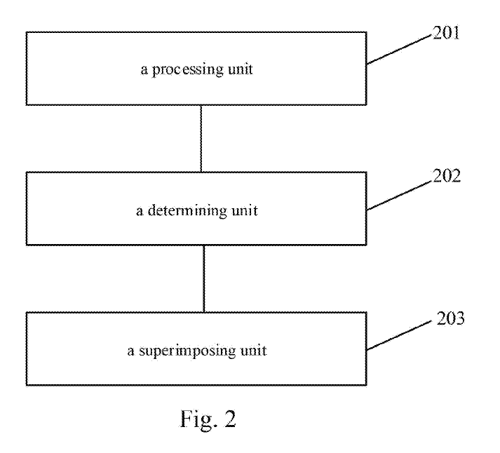

Referring to FIG. 2, as an implementation of the method shown in the above figure, the present disclosure provides an embodiment of an apparatus for augmenting reality. The embodiment of the apparatus corresponds to the embodiment of the method illustrated in FIG. 1.

As shown in FIG. 2, the apparatus for augmented reality includes: a processing unit 201, a determining unit 202, and a superimposing unit 203. The processing unit 201 is configured to recognize an object in an image collected by a camera of a user terminal, and determine a space occupied by the recognized object in a world coordinate system. The determining unit 202 is configured to determine a position in the world coordinate system corresponding to an augmented reality tag of the recognized object, and determine a superimposition position in the collected image corresponding to the position in the world coordinate system corresponding to an augmented reality tag of the recognized object. The position in the world coordinate system corresponding to the augmented reality tag of the recognized object is associated with the space occupied by the recognized object in the world coordinate system. The superimposing unit 203 is configured to superimpose the augmented reality tag at the superimposition position in an augmented reality.

In some alternative implementations of this embodiment, the processing unit includes: a space determining subunit. The space determining subunit is configured to determine a three-dimensional point of the recognized object in the world coordinate system, wherein the three-dimensional point corresponds to matched feature point of the recognized object in a plurality of images, and the plurality of images containing the recognized object are collected by the camera; and determine the space occupied by the recognized object in the world coordinate system according to positions of the three-dimensional points of the recognized object in the world coordinate system

In some alternative implementations of this embodiment, the apparatus for augmenting reality further includes: an augmented reality information superimposing unit, configured to superimpose, in the augmented reality, augmented reality information of the recognized object at the superimposition position, in response to detecting a static state duration of the user terminal being greater than a duration threshold, wherein the static state duration starting from a start moment of the user terminal being in the static state.

In some alternative implementations of this embodiment, types of the augmented reality information include: model, text, image, or video.

In some alternative implementations of this embodiment, the apparatus for augmented reality further includes: a progress presenting unit, configured to present a progress bar indicator to the user. The progress bar indicator indicates the static state duration of the user terminal since the start moment of the user terminal being in the static state.

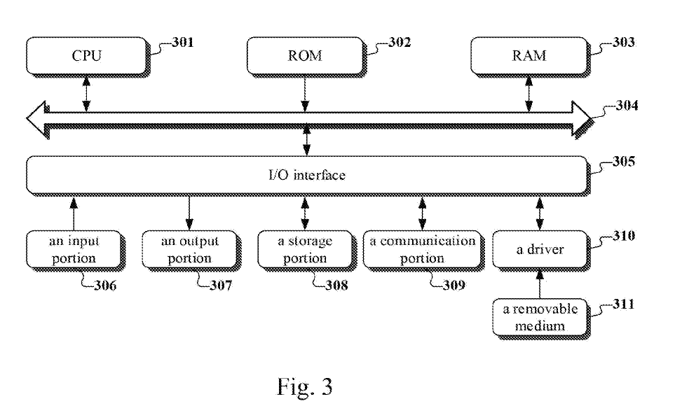

FIG. 3 illustrates a schematic structural diagram of a computer system adapted to implement a terminal of the embodiments of the present disclosure.

As shown in FIG. 3, the computer system includes a central processing unit (CPU) 301, which may execute various appropriate actions and processes in accordance with a program stored in a read-only memory (ROM) 302 or a program loaded into a random access memory (RAM) 303 from a storage portion 308. The RAM 303 also stores various programs and data required by operations of the system. The CPU 301, the ROM 302 and the RAM 303 are connected to each other through a bus 304. An input/output (I/O) interface 305 is also connected to the bus 304.

The following components are connected to the I/O interface 305: an input portion 306; an output portion 307; a storage portion 308 including a hard disk and the like; and a communication portion 309 comprising a network interface card, such as a LAN card and a modem. The communication portion 309 performs communication processes via a network, such as the Internet. A driver 310 is also connected to the I/O interface 305 as required. A removable medium 311, such as a magnetic disk, an optical disk, a magneto-optical disk, and a semiconductor memory, may be installed on the driver 310, to facilitate the retrieval of a computer program from the removable medium 311, and the installation thereof on the storage portion 308 as needed.

In particular, the process described in the embodiments of the present disclosure may be implemented as a computer program. For example, an embodiment of the present disclosure includes a computer program product, which comprises a computer program that is embedded in a machine-readable medium. The computer program comprises program instructions for executing the method as illustrated in the flow chart. The computer program may be downloaded and installed from a network via the communication portion 309, and/or may be installed from the removable media 311. The computer program, when executed by the central processing unit (CPU) 301, implements the above mentioned functionalities as defined by the methods of the present disclosure.

The present disclosure further provides a terminal configured with one or more processors and a processor storing one or more programs, where the one or more programs may contain instructions for implementing the operations descripted in the above steps 101-103. When the one or more programs are executed by the one or more processors, cause the one or more processor to implement the operations descripted in the above steps 101-103.

The present disclosure further provides a computer-readable storage medium. The computer-readable storage medium may be the computer storage medium included in the apparatus in the above described embodiments, or a stand-alone computer-readable storage medium not assembled into the apparatus. The computer-readable storage medium stores one or more programs. The one or more programs, when executed by a device, cause the device to: recognize an object in an image collected by a camera of a user terminal, and determining a space occupied by the recognized object in a world coordinate system; determine a position in the world coordinate system corresponding to an augmented reality tag of the recognized object, and determine a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and superimpose, in an augmented reality, the augmented reality tag at the superimposition position.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for augmenting reality, comprising:
recognizing an object in an image collected by a camera of a user terminal, and determining a space occupied by the recognized object in a world coordinate system;
determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and
superimposing, in an augmented reality, the augmented reality tag at the superimposition position.

2. The method according to claim 1, wherein the determining a space occupied by the recognized object in a world coordinate system comprises:
determining a three-dimensional point of the recognized object in the world coordinate system corresponding to a matched feature point of the recognized object, the recognized object being in a plurality of images containing the recognized object and collected by the camera; and
determining the space occupied by the recognized object in the world coordinate system based on a position in the world coordinate system of the three-dimensional point of the recognized object.

3. The method according to claim 2, further comprising:
superimposing, in the augmented reality, augmented reality information of the recognized object at the superimposition position, in response to detecting a static state duration of the user terminal being greater than a duration threshold, the static state duration starting from a start moment of the user terminal being in the static state.

4. The method according to claim 3, wherein types of the augmented reality information include: model, text, image, or video.

5. The method according to claim 4, further comprising:
presenting a progress bar indicator to the user, the progress bar indicator indicating the static state duration of the user terminal since the start moment of the user terminal being in the static state.

6. An apparatus for augmenting reality, comprising:
at least one processor; and
a memory storing instructions, the instructions when executed by the at least one processor, cause the at least one processor to perform operations, the operations comprising:
recognizing an object in an image collected by a camera of a user terminal, and determine a space occupied by the recognized object in a world coordinate system;
determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and
superimposing, in an augmented reality, the augmented reality tag at the superimposition position.

7. The apparatus according to claim 6, wherein the determining a space occupied by the recognized object in a world coordinate system comprises:
determining a three-dimensional point of the recognized object in the world coordinate system corresponding to a matched feature point of the recognized object, the recognized object being in a plurality of images containing the recognized object and collected by the camera; and determining the space occupied by the recognized object in the world coordinate system based on a position in the world coordinate system of the three-dimensional point of the recognized object.

8. The apparatus according to claim 7, wherein the operations further comprises:
superimposing, in the augmented reality, augmented reality information of the recognized object at the superimposition position, in response to detecting a static state duration of the user terminal being greater than a duration threshold, the static state duration starting from a start moment of the user terminal being in the static state.

9. The apparatus according to claim 8, wherein types of the augmented reality information include: model, text, image, or video.

10. The apparatus according to claim 9, wherein the operations further comprises:
presenting a progress bar indicator to the user, the progress bar indicator indicating the static state duration of the user terminal since the start moment of the user terminal being in the static state.

11. A non-transitory computer readable storage medium storing a computer program, wherein the computer program, when executed by a processor, cause the processor to perform operations, the operation comprising:
recognizing an object in an image collected by a camera of a user terminal, and determining a space occupied by the recognized object in a world coordinate system;
determining a position in the world coordinate system corresponding to an augmented reality tag of the recognized object, and determining a superimposition position in the collected image corresponding to the position in the world coordinate system corresponding to an augmented reality tag of the recognized object, the position in the world coordinate system corresponding to the augmented reality tag being associated with the space occupied by the recognized object in the world coordinate system; and
superimposing, in an augmented reality, the augmented reality tag at the superimposition position.
